(19) United States
(12) Patent Application Publication
(10) Pub. No.: US 2005/0284014 A1
(43) Pub. Date: Dec. 29, 2005

(54) Fish hook construction

(76) Inventor: Russell P. Cook, San Diego, CA (US)

Correspondence Address: Paul J. Cook, 115 Pine Street, Manchester, MA, 01944, US

(21) Appl. No.: 11/133,686

(22) Filed: May 23, 2005

Related U.S. Application Data
(63) Continuation-in-part of application No. 10/873,278, filed on Jun. 23, 2004.

(51) Int. Cl. A01K 83/00

(52) U.S. Cl. 43/43.16

(57) ABSTRACT

A fish hook construction is provided which comprises a hook shank, a hook barb attached to the hook shank by a hook elbow and a sleeve attached to the hook shank. A wing construction shaped to be asymmetric about a vertical axis of the hook shank is attached to the sleeve. A hydrofoil also is attached to the sleeve.

### REFERENCE TO RELATED APPLICATION

This application is a continuation-in-part of copending application Ser. No. 10/873,278, filed Jun. 23, 2004.

### BACKGROUND OF THE INVENTION

This invention relates to a fish hook construction adapted to increase the probability of implanting the hook into a fish and decreased the probability of swallowing the hook by a fish during use by the angler.

Prior to this invention, it has been proposed in U.S. Pat. No. 699,397 to provide a fish hook with a vane or a wing which extends in a direction from the hook shank directly opposite to the direction of extension of the hook. By utilizing such a wing or vane, when the line attached to the hook is pulled, the hook will move upwardly toward the direction of pull. This upward move is caused by the drag imposed by the wing or vane which functions as a fulcrum to provide the upward hook movement. If the hook is positioned so that the hook extends away from the fish, the sudden pulling and upward movement of the hook will cause the hook to move away from the fish thereby rendering the hook useless.

U.S. Pat. No. 2,713,742 discloses a fish hook having a baffle attached thereto to impart a zigzag motion to the hook.

U.S. Pat. Nos. 4,987,696; 5,056,257; 5,199,209 and 5,271,177 all disclose fish hook constructions having a hydrofoil construction design to cause the hook barb to lift when a pulling force is applied to a fish line. The hydrofoils are designed so that the hydrofoil portions on either side of the hook shank are symmetrical. These hydrofoil constructions do not allow the hook to spin about the axis of the shank.

Accordingly, it would be desirable to provide a hook construction which promotes spinning of the hook barb around the axis of the hook shank when a pulling force is applied to the hook through a line attached to the hook. In addition, it would be desirable to provide such a hook construction which causes the hook to be rotated upwardly about the point of attachment of the hook to a line. Such a construction would increase the probability of the hook being implanted into the mouth or jaw tissue of a fish.

### SUMMARY OF THE INVENTION

The present invention provides a fish hook construction comprising (a) a unitary construction including a barb, an elbow, a shank and means for attaching a line to the unitary construction and (b) a sleeve construction that fits around the shank and which includes two wings having an asymmetric shape about the axis of the shank and a hydrofoil that causes the barb to move upwardly by rotation about the means for attaching. The wings cause the hook to spin 360° about the axis of the shank. The wings are attached to two points about the sleeve and extend in two different directions.

### BRIEF DESCRIPTION OF THE DRAWINGS

FIG. 1 is a side view of a hook construction of this invention wherein the wings and hydrofoil are attached to the shank by a sleeve.

FIG. 2 is a back view of the hook construction of FIG. 1.

FIG. 3 is a cross sectional view taken along line 3-3 of FIG. 2.

### DESCRIPTION OF SPECIFIC EMBODIMENTS

In accordance with this invention, a hook construction is provided comprising a shank, an elbow attached to the shank, a barb attached to the elbow are a means for attaching the hook construction to a flexible line such as a loop. A sleeve having two wings and a hydrofoil is snap fit on the shank. The two wings are positioned on a sleeve and at an angle between 5 to 85 degrees from the vertical axis of the hook shank in a direction substantially perpendicular to the plane defined by the shank and elbow. The wings are constructed so that they have an asymmetric shape about the vertical axis of the shank in that the wings extend in opposite directions to each other. The hydrofoil also is positioned on the sleeve and it extends in a direction such that when a pulling force is applied to a line attached to the hook construction, the barb rotates upwardly about the point of attachment of the hook construction to a line.

In use, when a flexible line attached to the hook construction is pulled by the angler, the asymmetrical wing construction causes the hook to spin 360° about the vertical axis of the shank. In addition, the hydrofoil causes the barb to rotate upwardly about the point of attachment of the hook construction to the line. Thus, the fish hook of this invention provides a greatly improved probability that it will be implanted into the mouth of the fish during its use.

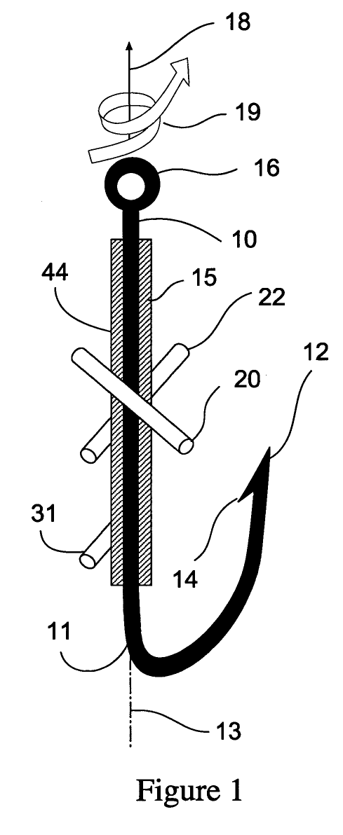

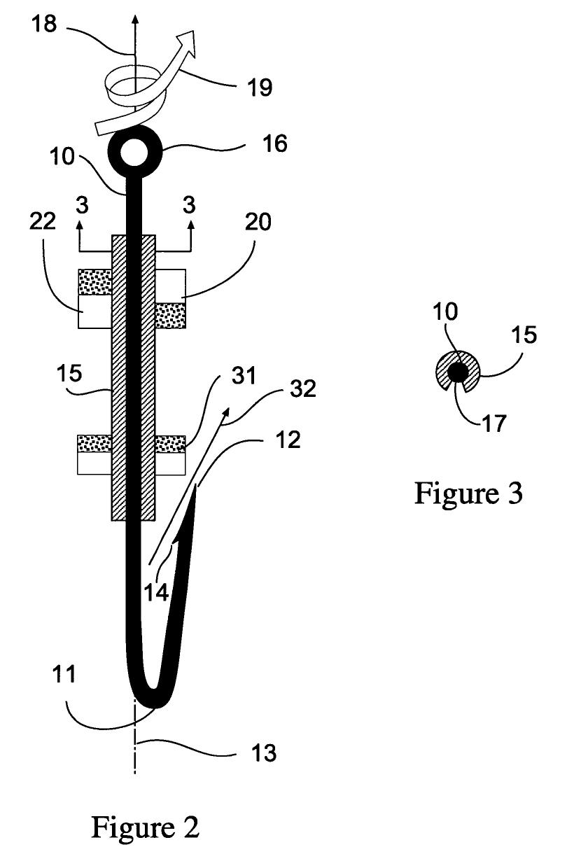

Referring to FIGS. 1, 2 and 3, the fish hook construction of this invention comprises a shank 10, an elbow 11, a barb 12, and a hook barb 14 of unitary construction. A loop 16 is attached to shank 10 in order to provide a means for attaching a line to the hook construction. A sleeve 15 is snap fit about the shank 10. The sleeve 15 has attached thereto two wings 20 and 22 extending in different, nonparallel directions to each other and a hydrofoil 31. The wings 20 and 22 extend in a direction between 5 to 85 degrees from the vertical axis 13 of the hook shank 10 as well as being positioned perpendicular to the plane defined by the shank 10 and hook elbow 11. As shown in FIG. 1, two wings 20 and 22 intersect each other. When a pulling force represented by arrow 18 is applied to the hook construction, the shank 10 spins about its vertical axis 13, 360° as represented by arrow 19. In addition, when the pulling force is applied to the hook, the barb 12 moves upwardly toward the loop 16 as represented by arrow 32.

The sleeve 15, wings 20 and 22 and hydrofoil 31 preferably can be formed of unitary construction from a flexible polymeric composition which can be molded in a conventional manner. The wings 20 and 22 can have the same size or different sizes. Since this unitary construction is flexible the size of the opening 17 which extends the length of sleeve 15 can vary so that the sleeve 15 can be positioned on shanks having varying diameters. Alternatively, the sleeve 15, wings 20 and 22 and hydrofoil 31 can be formed separately and then attached to each other in the configuration shown in FIGS. 1, 2 and 3 so as to achieve the motions represented by arrows 18 and 32.

1. A fish hook construction which comprises a hook shank, a hook barb attached to said shank by a hook elbow and defining one end of said construction, a sleeve which extends around said shank having attached thereto (1) a wing construction secured to said shank, said wing construction shaped to be asymmetric about a vertical axis of said shank so that when a pulling force is applied to said fish hook construction, said shank rotates 360° about said vertical axis of said shank and (2) a hydrofoil being shaped so that when a pulling force is applied to said fish hook construction, said hook rotates toward said line.

2. The construction of claim 1 wherein said wing construction comprises two wings having the same size.

3. The construction of claim 1 wherein said wing construction comprises two wings having different sizes.

4. An attachment adapted to fit about a shank of a fish hook construction, said hook having a hook shank, a hook barb attached to said shank by a hook elbow, said hook barb defining one end of said construction, and means for attaching said fish hook construction, said attachment comprising a hollow sleeve having a slot extending the entire length of said sleeve, said sleeve having a size to permit said sleeve to fit tightly about said hook shank, a wing construction secured to said sleeve, said wing construction shaped to be asymmetric about said shank so that when a pulling force is applied to said fish hook construction, said shank rotates 360° about a vertical axis of said shank and a hydrofoil secured to said sleeve, said hydrofoil being shaped so that when a pulling force is applied to said fish hook construction to a line attached to said fish hook construction, said hook rotates toward said line.

5. The construction of claim 4 wherein said wing construction comprises two wings having different sizes.

6. The construction of claim 4 wherein said wing construction comprises two wings having the same size.
